(19) United States
(12) Patent Application Publication
(10) Pub. No.: US 2019/0259122 A1
(43) Pub. Date: Aug. 22, 2019

(54) CUSTOMER RELATIONSHIP MANAGEMENT SYSTEMS AND METHODS FOR USE WITH REMOTE DEVICES

(71) Applicants: Stephen A. Crystal, Henderson, NV (US); Exequiel Segovia, Las Vegas, NV (US)

(72) Inventors: Stephen A. Crystal, Henderson, NV (US); Exequiel Segovia, Las Vegas, NV (US)

(21) Appl. No.: 16/283,737

(22) Filed: Feb. 22, 2019

Related U.S. Application Data
(60) Provisional application No. 62/795,478, filed on Jan. 22, 2019.
(60) Provisional application No. 62/634,183, filed on Feb. 22, 2018.

(51) Int. Cl. G06Q 50/34; G06Q 30/02; G07F 17/32

(52) U.S. Cl. CPC G06Q 50/34; G07F 17/3239; G06Q 30/0226

(57) ABSTRACT

A customer relationship management system involving the use of interaction data to deliver a special feature to customers.

### BACKGROUND OF THE INVENTION

The invention is directed to systems and methods for providing customer relationship management and marketing systems and methods in combination with a multi-purpose facility, such as a resort casino property, which may be used with and accessed by remote devices, such as customer smartphones and tablets. The term “casino” as it used herein is intended to cover some or all of a broad range of gaming and non-gaming offerings and services, such as entertainment, hospitality, hotel, restaurant and resort services, which are typically offered at casino establishments. Most casinos closely

[symbol]

Most casinos employ player tracking systems that manage data from gaming devices to enable player loyalty programs. While these systems are used to provide benefits to gaming players, many casino patrons also partake of the other non-gaming amenities offered by casinos. Some patrons spend more money on the non-gaming amenities than gaming yet player loyalty programs fail to take into account such non-gaming activities. Since these systems are not capable of detecting the full extent of a patron's interaction with a casino, and cannot provide a fuller understanding of the patron's habits, activities and interests. As a result, such systems are unable to provide benefits that are not only customized for each patron but are also better tailored to drive business for the casino from that patron in both gaming and non-gaming amenities. Furthermore, these systems are accessible primarily, if not wholly, within the casino itself, and may not be accessible at all to casino customers remotely.

Accordingly, there is a need for a casino management system which resolves the deficiencies in the art, including those indicated above, among other things.

### SUMMARY OF THE INVENTION

The present disclosure is directed to systems and methods that resolve the issues cited above and others.

Some embodiments of the invention are directed to a customer relationship management system, comprising: at least one processor; a user interaction server; at least one beacon broadcasting an identifier; a client application stored in memory of a remote device, wherein the remote device identifies a customer; and at least one memory device that stores an account for the customer and a plurality of instructions that, when executed by the at least one processor, cause the at least one client application to: a) communicate user interaction data to the user interaction server responsive to the remote device being detected within a preset proximity of the at least one beacon, wherein the user interaction data comprises an identification of the time of the detection and a unique identifier for the beacon; b) comparing the user interaction data to a preset criterion for a response; and c) communicate one of the awarding of a benefit or assigning a status to the customer account responsive to the user interaction data satisfying the preset criterion.

### BRIEF DESCRIPTION OF THE DRAWINGS

Other advantages of the invention will be readily appreciated as the same becomes better understood by reference to the following detailed description when considered in connection with the accompanying drawings. The components in the figures are not necessarily to scale, emphasis instead being placed upon illustrating the principles of the invention.

FIG. 1 is a block diagram illustrating some of the components of an exemplary system constructed in accordance with the invention.

### DETAILED DESCRIPTION OF THE INVENTION

The invention is generally directed to systems, methods and apparatus for providing, operating, hosting and conducting customer relationships comprising an interaction database configured to maintain customer interaction data, the customer interaction data representing interactions between a customer and a casino; receiving interaction data for customers, wherein the interaction data includes a determination of a customer's physical location and time within a casino, which may be facilitated by detection, receipt or communication of a signal between a detector or beacon and a customer device, such as a smartphone; processing the interaction data to determine whether the interaction data satisfies one or more preset criterion for a triggering event; and retrieving, responsive to a triggering event, a customer relationship management enhancement feature (a “CRM feature”), which may include an assignment of a status or distribution of a benefit. The assignment of a status may or may not be made known to the customer. The CRM feature may include variable characteristics that are further determined, such as by a prior assignment of a status to the customer. The CRM feature can be communicated to a remote device associated with the customer, such as a customer's smartphone.

In some embodiments, the CRM feature and/or one of the one or more variable characteristics associated therewith is determined by a processing device based at least partially on the triggering event and a comparison of the customer interaction data with one or more preset criterion for evaluating the customer relationship with the casino.

In some embodiments, the CRM feature and/or one of the one or more variable characteristics associated therewith is determined by a processing device based at least partially on the triggering event and a comparison of the customer interaction data with one or more preset criterion for evaluating the customer relationship with the casino.

Interaction data aggregation, analysis and communication of a CRM feature to a customer's remote device, such as a smartphone, are configured to facilitate improved CRM operations of a casino gaming floor, including providing for real-time detection of all interactions between a customer and a casino, including but not limited to, registering for a social and/or gaming account, game play information, and other activities, such as gaming, hotel, restaurant, resort and shopping activities.

The CRM feature may be anything of value, including monetary and non-monetary items, particularly items which involve further customer interaction with the casino. In some embodiments the CRM feature is free game play, whereas in other embodiments, the CRM feature is a free meal.

The triggering event may be based on any identifiable occurrence from gaming or non-gaming activities, such as a customer making a purchase at the casino or achieving a particular game result. A triggering event may be a customer being in a certain proximity inside or outside the casino, which may be determined based on geolocation technology installed within the casino or associated with the customer's smartphone. Triggering events may also be automatically set to occur periodically, such as monthly, prior to holidays or upon demand, such as for example, should the casino wish to offer a promotion to its customers.

The system of the invention may employ a point or grading system to assign a value to interaction data for the purpose of determining the CRM feature and any variable characteristics associated therewith. The grading system may assign a value based upon the extent and nature of a customer's interaction with both gaming and non-gaming services, such as the amenities at a casino as well as game play. For example, amounts bet, average wager, amounts won or lost, amount spent on entertainment, hotel room or other purchases, may all be assigned different values that can then either constitute a triggering event and/or be used to determine the CRM feature. In some embodiments, the interaction data is converted to points.

The CRM feature may be stored in a promotions database and have characteristics that can be categorized by hierarchal levels, wherein the CRM feature of the highest level is determined responsive to the interaction data being similarly graded. For example, the CRM feature may be tickets to a show, wherein the one or more variable characteristics may be the value of the seats. Thus, in this example, upon a triggering event, interaction data assigned higher grades will result in the seats selected for communication to the customer being from the higher level group and therefore of greater value.

Once the interaction data is identified it is stored in memory in connection with the customer, such as in a customer account stored in a customer account database. The interaction data may be, responsive to addition of new interaction data, periodically or upon demand, be compared with a list of triggering events to determine if a triggering event has occurred. Should a triggering event occur, the system shall consider the triggering event and/or the interaction data, which may be the totality of the interaction data and any assigned grades associated therewith in determining the CRM feature and any variable characteristics. For example, two customers may be offered a free meal responsive to the same triggering event but one of the two customers having a longer or more frequent recent history of interaction data may be offered a free meal of greater value than the other, such as a free meal at a different restaurant, a dinner as opposed to a lunch at the same restaurant or a free meal for two people as opposed to just one.

In some embodiments, the system of the invention enables a user to create custom modules for assessing interaction data, and responsive thereto, triggering an action or “payload” that may result in a benefit awarded to a customer, and/or assigning an achievement or status to the customer which is not readily visible to the customer.

In some embodiments, interaction data includes data received from various sources, such as: geo-fencing applications; Wi-Fi-detection of a customer device, such as a smartphone; use of a player or customer card, such as a player loyalty card being inserted into an electronic gaming machine; one or more proximity detectors which are configured to detect the presence of a customer within a certain proximity of the detector; and one or more transmitting devices which broadcast a signal, identifier or code that is received by a receiving device when the receiving device is within a certain range of the one or more transmitting devices.

For example, a detector of the invention may be a device which detects or communicates with a customer device, such as a smartphone, smartwatch, laptop, or casino provided implement, such as a casino chip. The proximity of the device to the detector results in the receiving of a communication indicating the same. The customer device may also detect the presence of the detector.

In some embodiments, the transmitter is Bluetooth low energy device or beacon that broadcasts an identifier that can be received by a customer device such as a smartphone, tablet, smartwatch or laptop for example.

The detection of a device, communication of a signal or receipt of an identifier may be interpreted by a software application stored in memory on the customer device. For example, a customer device may passively receive an identifier or code from one or more beacons located throughout a premises, with each code being recognized by the software application as part of the system of the invention and each beacon having a unique value associated with a preset location in the premises to facilitate the determination of the location of the customer device within the premises. By remaining in the proximity of a beacon, the detection may continue and be recognized to determine the time spent in the location.

The interaction data may be used by modules created within the system to better understand customer activity. For example, determining that a customer was in certain proximity such as the entrance of a casino at certain days and times can be interpreted to indicate the days and times the customer prefers to stay and play at the casino. This customer information can be further supported and expanded upon by interpretations of additional interaction data received, including interaction data provided by other geo-fencing data, wife connections, customer data, detectors and/or beacons. It should be understood that any or all of these devices and other sources of information may be received and interpreted by a systems constructed in accordance with the invention, and then used to trigger responses, including distributing a payload or benefit and assigning a hidden achievement.

For example, modules may be created to trigger a payload of an offer communicated to a customer smartphone, either through a software application or messaging service, to receive a benefit at a time when a customer is usually expected to be at a location based on receipt of interaction data over a period of time. Conversely, a payload of an offer may be triggered at a day and time when a customer normally is not at the casino in order to incentivize further customer interaction and patronage.

In some embodiments, a system of the invention includes data input/output communication devices, servers, memory, and one or more processors, among other things. The system is operatively associated with various sources of interaction data in a casino and on a casino website, mobile application or any other systems or devices capable of receiving or detecting customer interaction data, such as point of sale devices. The system is further operatively associated with casino management systems to detect data generated by casino gaming devices. The data from these sources is aggregated and associated with a customer provided that the customer is identified to the system, which may be by the customer's player loyalty card or identifying information, the customer's name, address or other personal identifying information. Interaction data received may include any information directly or indirectly relating to customer interactions with a casino.

The systems and methods of the invention are configured to communicate with both a casino system and a customer's smartphone. A customer may download and install a dedicated mobile application on a smartphone, as described below, to facilitate interaction with the casino. The customer may use the application to engage in interactions with the casino for both non-gaming and gaming purposes. For example, a customer can communicate with the casino staff, make a reservation at a restaurant and access information relating to their customer account stored in the account database, both inside and outside of a casino. In some embodiments, a customer may access gaming applications, such as live gaming or computerized gaming for fun, loyalty or other points or real money, where lawful.

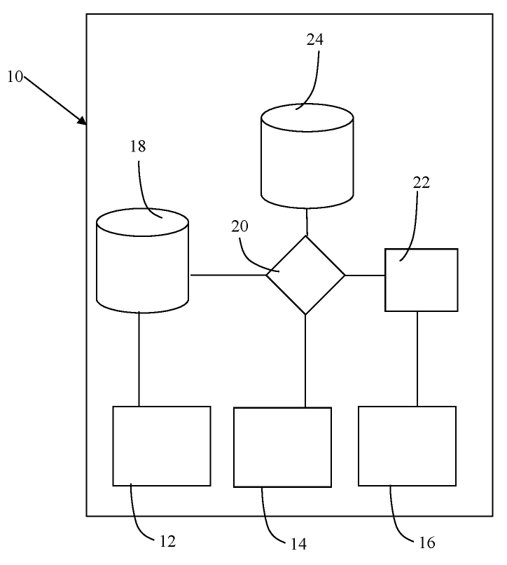

Referring to FIG. 1, a high-level schematic is shown of a system configured in accordance with an exemplary embodiment of the invention which is generally referred to as system 10. System 10 comprises an application module 12, an interaction data processing module 14 and a reporting module 16. In this embodiment or other embodiments, system 10 may include additional, fewer, or different modules for various applications. Conventional components such as network interfaces, security mechanisms, load balancers, failover servers, management and network operations consoles, and the like are not shown so as to not obscure the details of the system, but are contemplated as additional components of system 10.

System 10 is configured to provide, or causes to be provided, various user interfaces between system 10 modules 12, 14 and 16 and one or more devices, or client applications downloaded on one or more devices, which could comprise desktop computers, laptop computers, tablet computers, e-readers, mobile or smartphones, gaming devices, personal digital assistants, televisions, and other network-enabled media devices configured for communicating over a communication network such as the internet or other similar area networks through a wireless or hardwire connection, or a mixture thereof. These devices are not shown in order to simplify and clarify the description, but it is contemplated that thousands or more of such devices could be communicating over a network with system 10. Further, there may be multiple systems 10 in communication with each other and working together to provide the functionality of system 100 as described herein.

The user interfaces provided by system 10 can be any type of user interface, such as a graphical user interface (GUI) or a web-based user interface (WUI), which may include data entry fields and drop-down menus as appropriate.

Application module 12 provides a user interface to enable a user or network member to register, login and submit personal data which is stored in a user database 18. It should be understood that database 18 may comprise one or more databases. Personal data submitted through application module 12 is processed by a data processing device 20 and transmitted via data communication device 22 for inclusion in a multi-purpose property loyalty program, such as a casino loyalty program. The member account information may be stored in a database maintained by the property. The inclusion process may be automated by a system not shown herein which performs all necessary know your customer due diligence or other reviews.

Interaction data processing module 14 provides a user interface which enables users, such as casino personnel, to monitor user interaction data from patrons as described above, set payload and hidden achievement triggers, or directly provide any of the foregoing benefits among other things. Module 14 may be connected with database 18 to permit searching for patrons based on various criteria, such as for example, to identify all patrons that spend at least one hour within a certain area of the property on a particular day. Processing device 20 facilitates the search and retrieval of results responsive to the search query which are transmitted for display on the user interface via data communication device 22. User data processed by processing module 14 are stored in a user interaction database 24.

Reporting module 16 provides notifications to patrons, such as by the communicating with the patron's smartphone through text, email or through a client application, which may be provided by reporting module 16, which is downloaded and stored in the smartphone's memory, of the awarding CRM features or other benefits, or anything of interest, pursuant to any payload triggers or otherwise.

Some portions of the disclosure are presented in terms of algorithms (e.g., as represented in flowcharts, prose descriptions, or both) and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations or transformation of physical quantities or representations of physical quantities as modules or code devices, without loss of generality. However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “displaying,” “determining,” or the like, refer to the action and processes of a computer system, or similar electronic computing device (such as a specific computing machine), that manipulates and transforms data represented as physical (electronic) quantities within the computer system memories or registers or other such information storage, transmission or display devices.

It should be noted that the process steps and instructions of the embodiments can be embodied in software, firmware, or hardware, and when embodied in software, could be downloaded to reside on and be operated from different platforms used by a variety of operating systems. The embodiments can also be in a computer program product, which can be executed on a computing system.

Some embodiments also relate to an apparatus for performing the operations herein. Such an apparatus may be specially constructed for the purposes, e.g., a specific computer, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be a transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for the purposes of enablement and best mode.

Those skilled in the art will appreciate that the types of software and hardware used are not vital to the full implementation of the methods of the invention. The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

While exemplary systems and methods, and applications of methods of the invention, have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Additional information regarding exemplary embodiments of the invention is provided below.

### Computer program

In some embodiments, the methods, systems, and media disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, Node, React, Redux or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software modules

In some embodiments, the methods, systems, and media disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the methods, systems, and media disclosed herein include one or more databases, or use of the same. In view of the disclosure provided herein, those of skill in the art will recognize that many databases are suitable for storage and retrieval of player and game information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based.

In still further embodiments, a database is cloud computing-based. In other embodiments, a database is based on one or more local computer storage devices.

### General information relating to various embodiments of the invention

A controller, computing device, or computer, such as described herein, may include at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

In some embodiments, a controller may include a processor, which as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing system or device. Systems of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as users, content providers and operators thereof are provided with useful access thereto, either through a mobile device, system, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

While exemplary apparatus, systems and methods of the invention have been described herein, it should also be understood that the foregoing is only illustrative of a few particular embodiments with exemplary and/or preferred features, as well as principles of the invention, and that various modifications can be made by those skilled in the art without departing from the scope and spirit of the invention. Therefore, the described embodiments should not be considered as limiting of the scope of the invention in any way. Accordingly, the invention embraces alternatives, modifications and variations which fall within the spirit and scope of the invention as set forth by the claims and any equivalents thereto.

1. A customer relationship management system, comprising:
at least one processor;
a user interaction server;
at least one beacon broadcasting an identifier;
a client application stored in memory of a remote device, wherein the remote device identifies a customer;
and at least one memory device that stores an account for the customer and a plurality of instructions that, when executed by the at least one processor, cause the at least one client application to:
a) communicate user interaction data to the user interaction server responsive to the remote device being detected within a preset proximity of the at least one beacon, wherein the user interaction data comprises an identification of the time of the detection and a unique identifier for the beacon;
b) comparing the user interaction data to a preset criterion for a response; and
c) communicating one of the awarding of a benefit or assigning a status to the customer account responsive to the user interaction data satisfying the preset criterion.
